(19) United States
(12) Patent Application Publication
(10) Pub. No.: US 2025/0328335 A1
(43) Pub. Date: Oct. 23, 2025

(54) Canary Deployments Based On Configuration Complexity In Containerized Environments

(71) Applicant: Dell Products L.P., Round Rock, TX (US)

(72) Inventors: Boris Shpilyuck, Ashdod (IL); Jehuda Shemer, Kfar Saba (IL); Igor Dubrovsky, Beer-Sheva (IL)

(21) Appl. No.: 18/643,897

(22) Filed: Apr. 23, 2024

(51) Int. Cl. G06F 8/65

(52) U.S. Cl. CPC G06F 8/65

(57) ABSTRACT

A system can determine a complexity of configuration changes between first and second versions of configuration information of an executable program that corresponds to a microservice of a group of microservices. The system can determine a number of steps of a progressive deployment plan for the microservice based on the complexity of the configuration changes. The system can determine first and conditions of the progressive deployment plan for the microservice based on the complexity of the configuration changes. The system can generate the progressive deployment plan for the microservice based on the number of steps, the first condition, and the second condition, wherein a first amount of complexity of the complexity of changes corresponds to a faster progressive deployment relative to a second amount of complexity of the complexity of changes. The system can direct computer network traffic to the microservice based on the progressive deployment plan.

### BACKGROUND

Computer programs that are operating in production can be updated, and these updated versions of the programs can be introduced into production.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine a complexity of configuration changes between a first version of configuration information of an executable program that corresponds to a microservice of a group of microservices and a second version of the configuration information, wherein the executable program is deployed according to the first version of the configuration information, and wherein the executable program is to be deployed according to the second version of the configuration information to replace the executable program deployed according to the first version of the configuration information. The system can determine a number of steps of a progressive deployment plan for the microservice based on the complexity of the configuration changes. The system can determine a first condition of the progressive deployment plan for the microservice based on the complexity of the configuration changes, wherein the first condition comprises a number of requests handled by the microservice in directing the traffic to the microservice at a current step of the number of steps before moving to a next step of the number of steps. The system can determine a second condition of the progressive deployment plan for the microservice based on the complexity of the configuration changes, wherein the second condition comprises an amount of time spent in directing the traffic to the microservice at the current step before moving to the next step. The system can generate the progressive deployment plan for the microservice based on the number of steps, the first condition, and the second condition, wherein a first amount of complexity of the complexity of changes corresponds to a faster progressive deployment relative to a second amount of complexity of the complexity of changes, and wherein the first amount of complexity indicates less-complex changes than the second amount of complexity. The system can direct computer network traffic to the microservice based on the progressive deployment plan.

An example method can comprise determining, by a system comprising at least one processor, a complexity of configuration changes between a first version of configuration information of an executable program that corresponds to a microservice of a group of microservices and a second version of the configuration information, wherein the first version of the executable program is deployed, and wherein the second version of the executable program is to be deployed to replace the first version of the executable program. The method can further comprise determining, by the system, a number of steps of a progressive deployment plan for the microservice based on the complexity of configuration changes. The method can further comprise determining, by the system, a first condition of the progressive deployment plan for the microservice based on the complexity of configuration changes, wherein the first condition comprises a number of requests handled by the microservice in directing the traffic to the microservice at a current step of the number of steps before moving to a next step of the number of steps. The method can further comprise determining, by the system, a second condition of the progressive deployment plan for the microservice based on the complexity of configuration changes, wherein the second condition comprises an amount of time spent in directing the traffic to the microservice at the current step before moving to the next step. The method can further comprise generating, by the system, the progressive deployment plan for the microservice based on the number of steps, the first condition, and the second condition, wherein a first amount of complexity of the complexity of changes corresponds to a faster progressive deployment relative to a second amount of complexity of the complexity of changes, and wherein the first amount of complexity indicates less-complex changes than the second amount of complexity. The method can further comprise directing, by the system, computer network traffic to the microservice based on the progressive deployment plan.

An example non-transitory computer-readable medium can comprise instructions that, in response to execution, cause a system comprising a processor to perform operations. These operations can comprise determining a complexity of configuration changes between two versions of configuration information for executable instructions that correspond to a computer program, wherein a version of the two versions corresponds to an updated version of configuration data and an updated instance of the computer program, wherein another of the two versions comprises a current version of the configuration information that was used in instantiating a current instance the computer program. These operations can further comprise determining a number of steps of a progressive deployment plan for the updated instance of the computer program based on the complexity of configuration changes. These operations can further comprise determining a condition of the progressive deployment plan for the updated instance of the computer program based on the complexity of configuration changes, wherein the condition comprises a number of requests handled by the updated instance of the computer program in directing the traffic to the updated instance of the computer program at a current step of the number of steps before moving to a next step of the number of steps, or wherein the condition comprises an amount of time spent in directing the traffic to the updated instance of the computer program at the current step before moving to the next step. These operations can further comprise generating the progressive deployment plan for the updated instance of the computer program based on the number of steps and the condition, wherein a first amount of complexity of the complexity of changes corresponds to a faster progressive deployment relative to a second amount of complexity of the complexity of changes, and wherein the first amount of complexity indicates less-complex changes than the second amount of complexity. These operations can further comprise dividing computer network traffic between the updated instance of the computer program and the current version of the computer program based on the progressive deployment plan.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate canary deployments based on configuration complexity in containerized environments, in accordance with an embodiment of this disclosure;

FIG. 2 illustrates another example system architecture that can facilitate canary deployments based on configuration complexity in containerized environments, in accordance with an embodiment of this disclosure;

FIG. 3 illustrates another example system architecture that can facilitate canary deployments based on configuration complexity in containerized environments, in accordance with an embodiment of this disclosure;

FIG. 4 illustrates an example graph for increasing traffic directed to a canary version, and that can facilitate canary deployments based on configuration complexity in containerized environments, in accordance with an embodiment of this disclosure;

FIG. 5 illustrates an example configuration that can facilitate canary deployments based on configuration complexity in containerized environments, in accordance with an embodiment of this disclosure;

FIG. 6 illustrates an example process flow that can facilitate canary deployments based on configuration complexity in containerized environments, in accordance with an embodiment of this disclosure;

FIG. 7 illustrates an example process flow that can facilitate canary deployments based on configuration complexity in containerized environments, in accordance with an embodiment of this disclosure;

FIG. 8 illustrates an example process flow that can facilitate canary deployments based on configuration complexity in containerized environments, in accordance with an embodiment of this disclosure;

FIG. 9 illustrates an example process flow that can facilitate canary deployments based on configuration complexity in containerized environments, in accordance with an embodiment of this disclosure;

FIG. 10 illustrates an example process flow that can facilitate canary deployments based on configuration complexity in containerized environments, in accordance with an embodiment of this disclosure;

FIG. 11 illustrates an example block diagram of a computer operable to execute an embodiment of this disclosure.

### DETAILED DESCRIPTION

### Overview

The present techniques generally relate to automating upgrade processes of live systems. In contemporary containerized environments, new changes can be introduced in a form of “canary deployments.” That is, an “old” version of the microservice (which can be referred to as a production version) and a “new” version that contains the change (which can be referred to as a canary version) can be active at the same time. It can be that, initially, a canary version receives just a small portion of traffic in order to minimize how widely problems can spread.

Then, where no problems are encountered, an amount of traffic to the canary version can be increased gradually by a canary deployment operator, until 100% of the traffic is switched to the canary version. After that, the “old” production version can be decommissioned, and a canary version can be labeled as the production version. There can be a question is how much traffic should be directed to the canary version, and at what rate should the traffic be increased.

A problem with prior approaches can be as follows. Canary deployment operators can define the amount of traffic that will be forwarded to the canary version of the microservice at each step of canary deployment manually and without relation to the committed changeset's complexity. Therefore, it can be that simple changes can take too much time to deploy. And vice versa-complex change can receive a significant amount of traffic too quickly, which can lead to too many users being affected by possible issues.

The present techniques can be implemented to mitigate this problem. After code submission, a complexity of a configuration changeset can be analyzed, and a corresponding canary deployment plan can be created based on the changeset's complexity. The plan can define a number of steps, and an amount of the traffic that will be forwarded to the canary version of the microservice per each step. It can be that, the more complex the change, the more gradual and more verified be the progress towards a full switch to the canary version. The present techniques can be implemented to address a change in configuration (compared with code and interfaces), and how that affects the canary deployment.

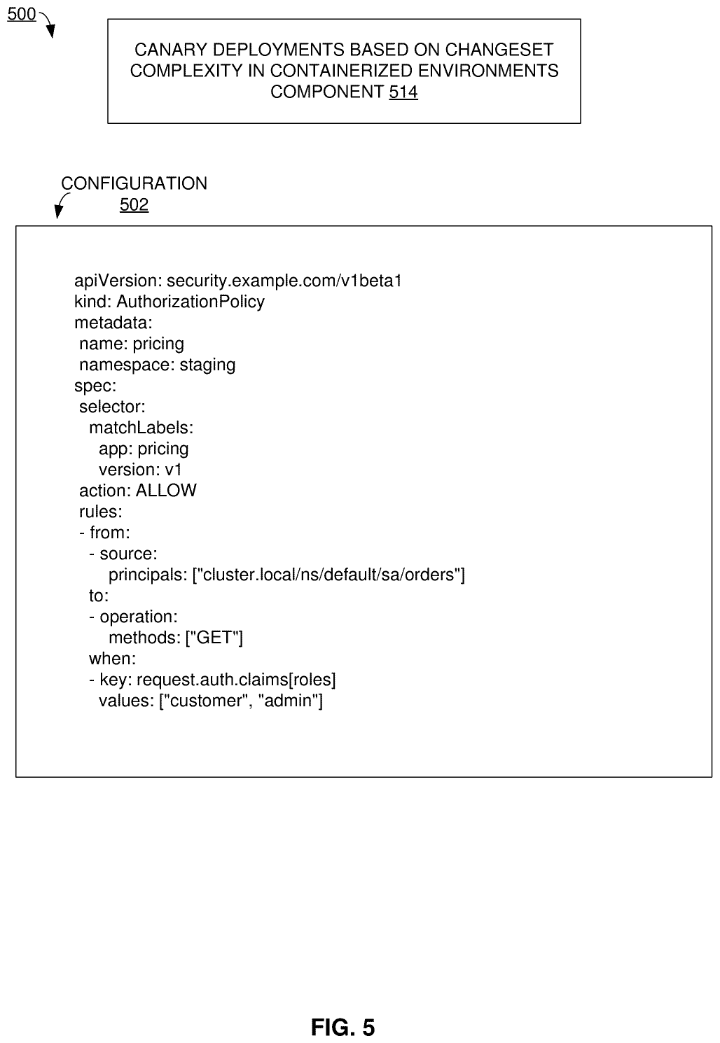

Configuration information (such as illustrated in FIG. 5) can comprise metadata about how to deploy a microservice, and that is separate from the computer-executable instructions that make up the microservice. For example, configuration information can indicate how many instances of a microservice to deploy.

Prior approaches to canary deployments can require manual orchestration. In some examples, a canary deployment operator decides at each step what percent of traffic to forward to a canary version. In a case where there are a few different computing clusters and hundreds of microservices, this can be significant and error-prone manual labor.

Prior approaches to canary developments can have a “blast radius” that is too wide. Where a service comprises hundreds or thousands of microservices, it can be difficult to analyze every configuration change manually, and provide a corresponding deployment plan that takes into consideration configuration change complexity. As a result, it can be that a manual averaged plan is adopted for all canary deployments. Implementing an average plan for all deployments can mean that the deployment process is too fast for some complex changesets, thus affecting too many users in case of possible issues.

Prior approaches to canary developments can utilize too slow of a propagation time. Where a manual averaged plan is adopted for all canary deployments (as described above), for simple changesets, the deployment progress can be too slow. This can negatively impact feature rollout time.

The present techniques can be implemented to facilitate providing automatic canary deployments, thus reducing manual and error-prone labor. Canary deployments can be orchestrated according to a canary deployment plan that takes into consideration a complexity of a configuration change. This approach can achieve an acceptable balance between passing deployments through at a reasonable rate, while also not affecting too many users in a case of a problem with the deployed changeset.

According to the present techniques, a configuration change complexity analyzer can analyze a configuration change's complexity based on a group of metrics. A canary plan generator can generate a canary deployment plan based on the configuration change's complexity. A canary deployment orchestrator can orchestrate the canary deployment plan.

In some examples, the present techniques can be implemented where an existing microservice, or group of microservices, has undergone configuration changes. The new versions of the microservice(s) can be deployed in parallel with older versions that are currently in production. Traffic portions between the old and the new versions can be progressively orchestrated.

In another example, an additional microservice, or group of microservices, can be deployed or removed as part of a configuration change that can include some existing deployed microservices. Similar to the above, traffic can be progressively directed to this new group of microservices.

A complexity rank of each specific changeset can be determined based on a complexity of the source code that comprises the changeset. If a configuration of a microservice has changed, this can be a different determination.

A configuration of a microservice can control critical aspects of its behavior, such as
Performance-how many instances can be instantiated, an amount of resources available, etc.
Security-which users/roles can access a particular application programming interface (API).
Traffic management-retries, fault injection, and traffic restrictions to/from certain microservices.

A question can relate to how to factor in complexity of configuration changes into an automatic canary deployment process.

An augmented complexity rank determination that factors in configuration changes can be implemented as follows. A configuration can be represented in a form of a format like Extensible Markup Language (XML), JavaScript Object Notation (JSON), or Yet Another Markup Language (YAML). While the syntax of those formats can vary, in essence, those formats can be represented as a tree where each node represents either a specific configuration change or a grouping of configuration changes.

Based on that, metrics can be expressed to convey a complexity of a configuration change. These metrics can include:
A number of lines of the configuration change;
An average path length from the root to the leaves (which can reflect on a nesting level);
An average number of “children” of a node (which can reflect on an exploration of configuration groupings);
A percentage of non-leaf nodes;
A percentage of leaf nodes;
A number of interpolation points (placeholders) in a configuration's values;
With configurations that pertain to scale-out limits-changes from 1 to more than 1;
A subject matter of the change (security, scale, etc.).

In some examples, these metrics can represent an amount of change between a prior version of the configuration information and a new version of the configuration information. There can be other metrics used, such as ones that reflect more domain-specific configuration options.

Regarding leaves, children, etc., consider the following example excerpt from a configuration:

```
spec:
  selector:
  matchLabels:
    app: pricing
    version: v1
```

A leaf node can comprise a node that indicates a value (e.g., a value of “pricing” in “app: pricing”). A non-leaf node can comprise a selector that lacks a value (e.g., “matchLabels:”). Here, a path length from a root (“spec”) to leaves (e.g., “app: pricing”) can be 4 (“spec” to “selector” to “matchLabels” to “app: pricing”). A number of children of this node can be two (“app: pricing” and “version: v1”). A percentage of non-leaf nodes can be 60% (five total nodes, where “spec,” “selector,” and “matchLabels” are non-leaf nodes. A percentage of leaf nodes can be 40% (the five total nodes, where “app: pricing” and “version: v1” are leaf nodes).

In some examples, each metric can be associated with a weight that reflects that metric's significance for a determination of a complexity of the change. Using a set of metrics and their weights, a complexity rank can be determined as described below. Subsequently, canary deployment management can be performed according to a determined calculated complexity rank, and then fed into a changeset complexity analyzer.

The present techniques can facilitate producing automatic canary deployments, thus reducing manual and error prone labor. The canary deployments can be orchestrated according to a canary deployment plan that takes into consideration configuration complexity and changeset complexity. This can allow achieving an acceptable balance between passing deployments through at a reasonable rate, while also not affecting too many users in case of any problem with the deployed changeset.

### Example Architectures

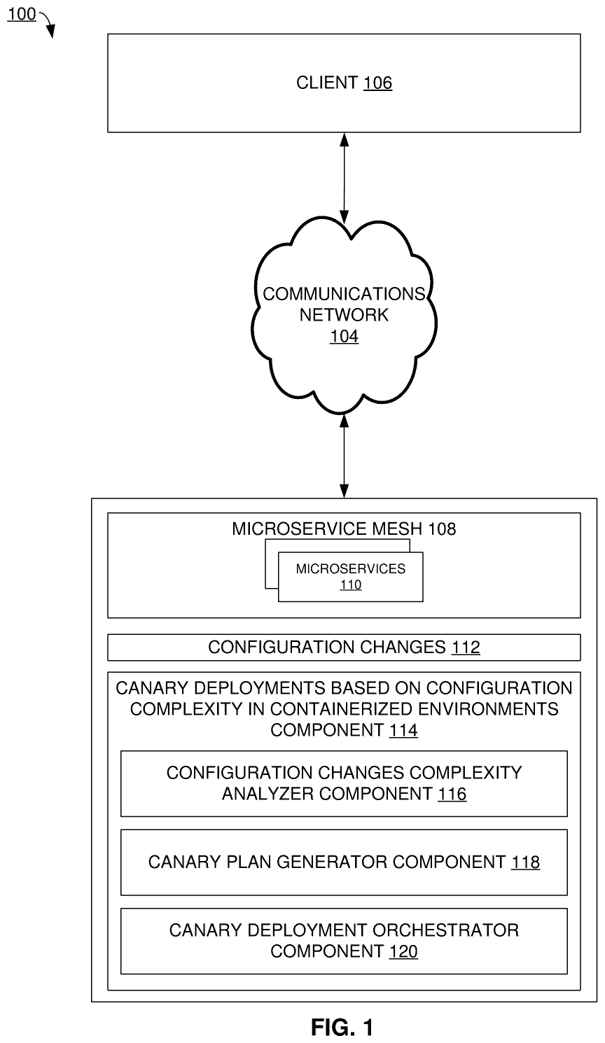

FIG. 1 illustrates an example system architecture 100 that can facilitate canary deployments based on configuration complexity in containerized environments, in accordance with an embodiment of this disclosure.

System architecture 100 comprises server 102, communications network 104, and client 106. In turn, server 102 comprises microservices mesh 108, configuration changes 112, and canary deployments based on configuration complexity in containerized environments component 114. Microservices mesh 108 comprises microservices 110. canary deployments based on configuration complexity in containerized environments component 114 comprises configuration changes complexity analyzer component 116, canary plan generator component 118, and canary deployment orchestrator component 120.

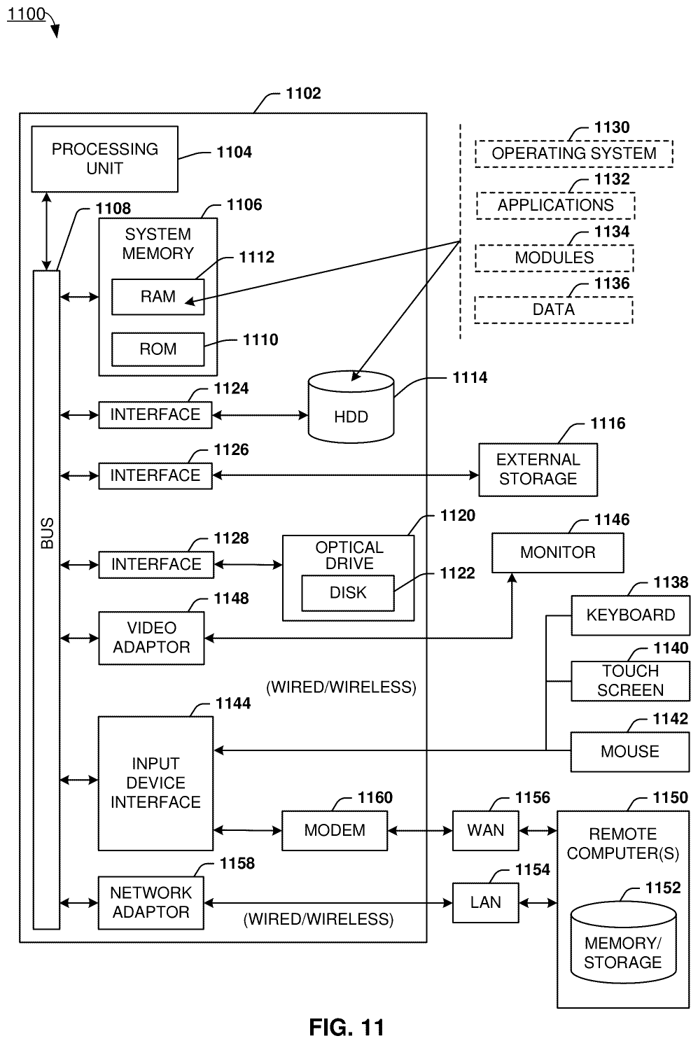

Each of server 102 and/or client 106 can be implemented with part(s) of computing environment 1100 of FIG. 11. Communications network 104 can comprise a computer communications network, such as the Internet.

Microservices 110 can operate collectively to provide a computing service that is accessible by client 106 via communications network 104. Microservices 110 can be containerized, where each microservice operates in a separate computing container. This can be referred to as a “containerized environment.”

Over time, an entity that creates microservices 110 can update configuration information used for the microservices. This updated configuration information can be stored as configuration changes 112. It can be that an entity that manages microservices 110 wants to perform a progressive deployment (sometimes referred to as a “canary deployment”) of gradually increasing traffic to a new version of a particular microservice, and from an older version of that particular microservice that is currently in production. This can be to identify errors with the new version before the new version serves all users.

Performing such a canary deployment can be performed by canary deployments based on configuration complexity in containerized environments component 114. Configuration changes complexity analyzer component 116 can determine a complexity of configuration changes 112. Canary plan generator component 118 can determine a plan for progressively deploying the new version of the microservice based on the result of configuration changes complexity analyzer component 116. Canary deployment orchestrator component 120 can implement a progressive deployment of the new version of the microservice based on the plan determined by canary plan generator component 118.

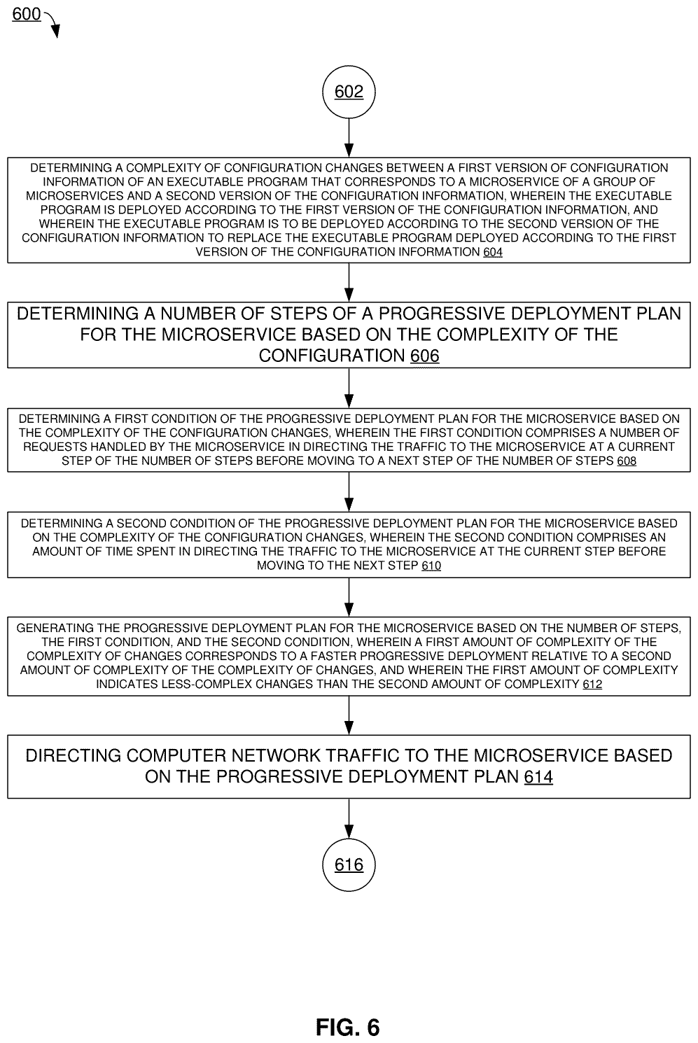

In some examples, canary deployments based on configuration changes complexity in containerized environments component 114 can implement part(s) of the process flows of FIGS. 6-10 to facilitate canary deployments based on configuration complexity in containerized environments.

It can be appreciated that system architecture 100 is one example system architecture for proactive prevention of data unavailability and data loss, and that there can be other system architectures that facilitate canary deployments based on configuration complexity in containerized environments.

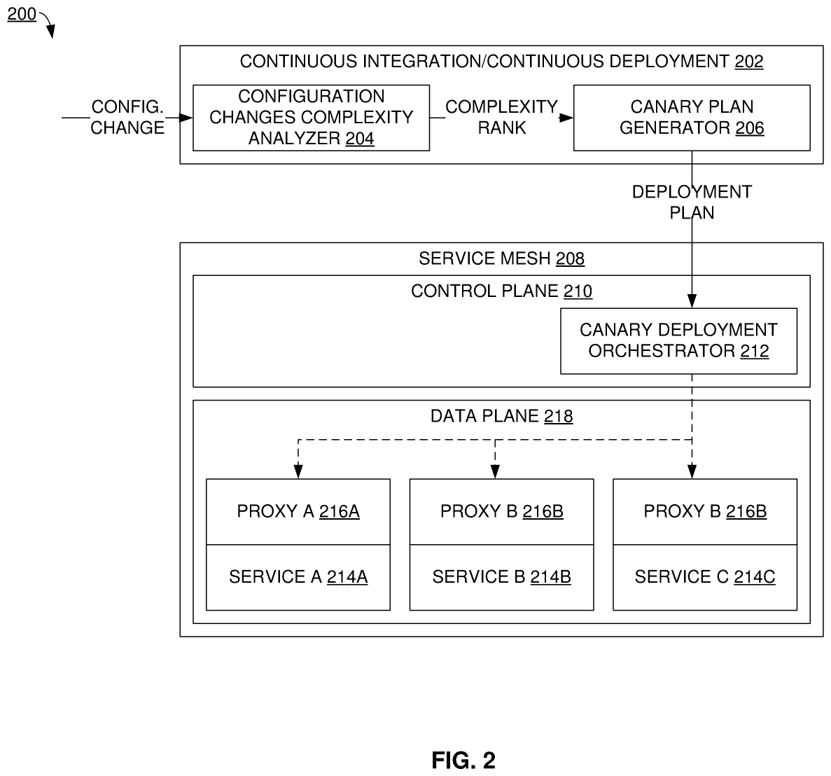

FIG. 2 illustrates another example system architecture 200 that can facilitate canary deployments based on configuration complexity in containerized environments, in accordance with an embodiment of this disclosure. In some examples, part(s) of system architecture 200 can be implemented by system architecture 100 to facilitate canary deployments based on configuration complexity in containerized environments.

System architecture 200 comprises continuous integration/continuous deployment 202, configuration changes complexity analyzer 204 (which can be similar to configuration changes complexity analyzer component 116 of FIG. 1), canary plan generator 206 (which can be similar to canary plan generator component 118), service mesh 208, control plane 210, canary deployment orchestrator 212 (which can be similar to canary deployment orchestrator component 320), service A 214A, service B 214B, service C 214C, proxy A 216A, proxy B 216B, proxy C 216A, and data plane 218.

Continuous integration/continuous deployment 202 can comprise a computer component that facilitates building, testing and deployment of programs. Service mesh 208 can comprise a computer component that facilitates an infrastructure layer for facilitating service-to-service communications between services or microservices (e.g., service 214A-C), using a proxy (e.g., proxy 216A-C). Control plane 210 can comprise a part of service mesh 208 that manages and configures proxies. Data plane 218 can comprise a part of service mesh 208 that facilitates communication between services and load balancing between multiple instances of a given service.

In some examples, the present techniques can encompass analyzing a configuration change's complexity; generating a canary deployment plan based on the configuration change's complexity; and automatically orchestrating the canary deployment based on the generated canary deployment plan.

A system that implements the present techniques can comprise configuration changes complexity analyzer 204, canary plan generator 206, and canary deployment orchestrator 212. System architecture 200 presents these components logically, and it can be appreciated that there can be other systems that implement the present techniques in a different manner.

Configuration changes complexity analyzer 204 can be incorporated into an ecosystem of continuous integration/continuous deployment (CI/CD) 202, and upon submission of a configuration change (e.g., configuration changes 112 of FIG. 1), determine a configuration change's complexity, then produce a complexity rank (e.g., a numeric value between 1 and 100) according to the corresponding complexity.

Canary plan generator 206 can be incorporated into an ecosystem of continuous integration/continuous deployment 202. Canary plan generator 206 can use a complexity rank produced by configuration changes complexity analyzer 204, and generate a corresponding canary deployment plan.

A canary deployment plan can comprise a list of steps, and conditions to move to a next step, in a canary deployment. Each step can identify a counter of a minimum number of requests that should be handled at this step; a minimum amount of time to stay in this step; and/or other conditions.

A canary deployment plan can indicate both a minimum number of calls processed and a minimum amount of time that passes to move to a next step in a canary deployment. For example, a canary deployment plan can indicate a minimum of both 1,000 requests and 90 seconds. That is, the process can stay in this step until at least 1,000 requests have been processed, and at least 90 seconds have passed in this step. This can ensure that exposure is significant, and that the system has had enough time to propagate a result. Where either parameter is defined as 0 in a canary deployment plan, it can indicate that only one aspect is the trigger to move to a next step.

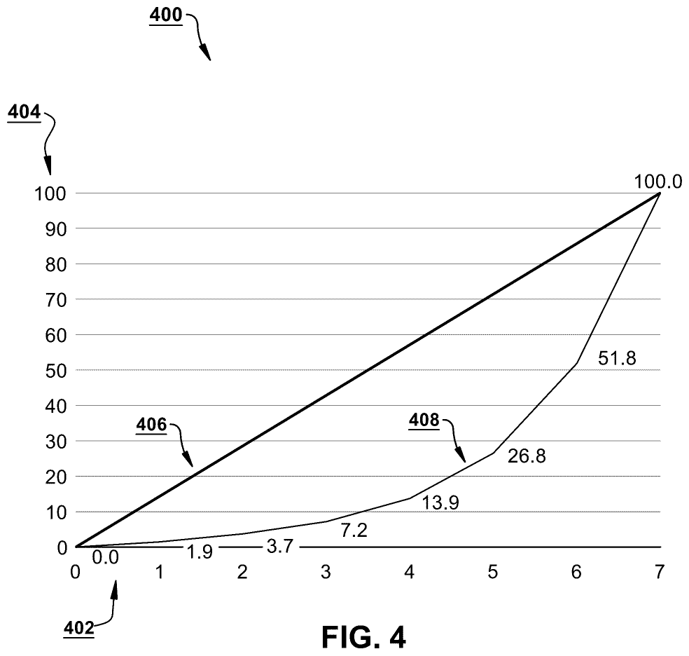

In some examples, defining each step separately can be performed, and can allow for granular control. In other examples, a canary plan generator can simplify a generation of steps by using a function to define the steps, and fixed parameters for the rest. Such a function can be a monotonically increasing function, as depicted in graph 400 of FIG. 4.

Additionally, with a canary deployment plan, a fixed number of requests and a fixed amount of time per step can be used. In other examples, these values can be a function of the step number—e.g., 1,000 requests for step 1, 2,000 requests for step 2, etc. (and a similar approach for the time values).

In some examples, a basic canary deployment plan can therefore be made up of a triplet—[# steps, # requests, # time]. Expressed in more detail, this can be, [number of steps, minimum number of requests to be forwarded to the canary version per step, minimum time to stay per step].

In some examples, a canary deployment plan can have additional parameters to govern behavior of corresponding functions.

The present examples can generally involve using an Nth root function (similar to function 408 of FIG. 4), and a fixed number of requests and amount of time for a step.

For example, a canary deployment plan of [7, 5,000, 30] can mean that there are 7 steps, and in order to move to the next step both 5,000 requests must be forwarded to the canary version of the microservice, and at least 30 seconds must elapse in that step. The percentage of traffic that will be forwarded to the canary version for each step is, for instance, 1.93%, 3.73%, 7.20%, 11.9%, 26.82%, 51.8%, 100%. That is, as there are 7 steps in this example, each step is based on the 7th root of 100, e.g., 100\hat{ }( 1/7), 100\hat{ }( 2/7), . . . 100\hat{ }(7/7) (which is 100%).

Combined together, in some examples, the higher the complexity rank, the more steps there will be, and the slower the percentage of request forwarded to the canary version per each step and time in each is. This approach can allow achieving an acceptable balance between passing deployments through at a reasonable rate, but also not affecting too many users in case there is a problem with the configuration changes.

In some examples, as described herein, a number of steps can be automatically derived, and a complete canary deployment plan can also be automatically derived as a result.

Canary deployment orchestrator 212 can be incorporated into an ecosystem of service mesh 208.

Service mesh 208 can generally comprise a dedicated infrastructure layer that allows the transparent addition of capabilities like observability, traffic management, security, and canary deployments, without adding them to the code of a specific service. In some examples, in order to support canary deployments, a canary deployment operator can use a service mesh's ability to split traffic between production and canary versions at a given proportion. However, this approach can be a manual process, with the proportion itself specified by the canary deployment operator.

Upon a continuous integration/continuous deployment's pipeline completion, canary deployment orchestrator 212 can get a canary deployment plan produced by canary plan generator 206, and automatically execute it step-by-step. Canary deployment orchestrator 212 can verify that, per each step, the relevant percentage of requests are forwarded to the canary version. Once the required number of requests per step are achieved, and the required time has passed, canary deployment orchestrator 212 can move to a next step (with a higher canary traffic percentage), and so on, until everything is switched to the canary version (where the canary version is operating successfully).

In the example of system architecture 200, configuration changes complexity analyzer 204 and canary plan generator 206 are incorporated into an ecosystem of continuous integration/continuous deployment 202, while canary deployment orchestrator 212 is incorporated into a control plane ecosystem of the service mesh 208. Configuration changes complexity analyzer 204 can receive a configuration change, determine its complexity rank, and pass that information to canary plan generator 206. Canary plan generator 206 can generate a canary deployment plan, and pass the canary deployment plan to canary deployment orchestrator 212, which, in turn, can instruct the service mesh's proxies (e.g., proxy 216A-C) to split the traffic between canary versions and production versions of a service (e.g., service 214A-C) in proportion as defined by the canary deployment plan.

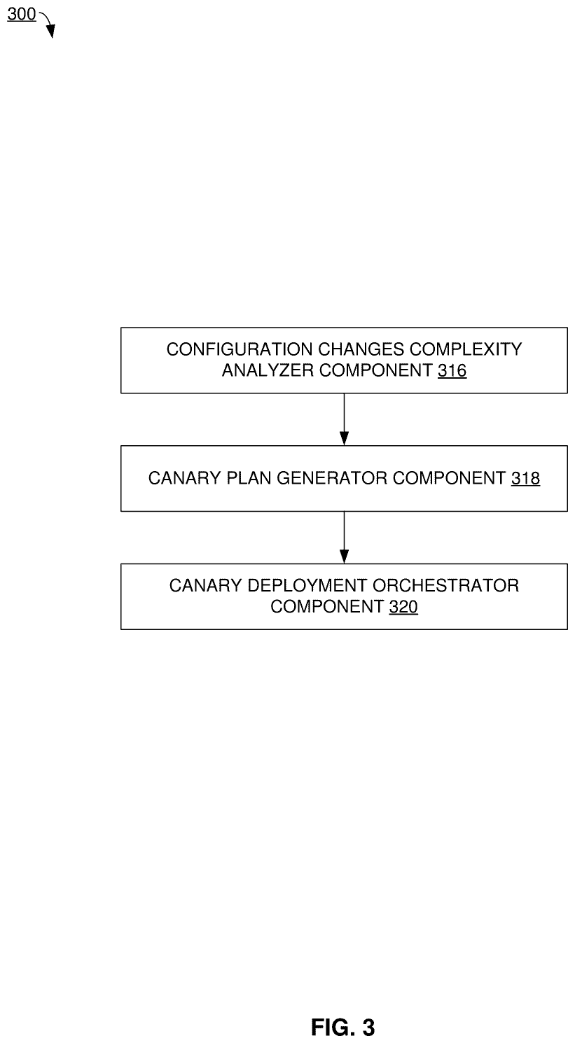

FIG. 3 illustrates another example system architecture 300 that can facilitate canary deployments based on configuration complexity in containerized environments, in accordance with an embodiment of this disclosure.

System architecture 300 comprises configuration changes complexity analyzer component 316, canary plan generator component 318, and canary deployment orchestrator component 320. Configuration changes complexity analyzer component 316, canary plan generator component 318, and canary deployment orchestrator component 320 can be similar to configuration changes complexity analyzer component 116, canary plan generator component 118, and canary deployment orchestrator component 120 of FIG. 1, respectively.

It can be appreciated that system architecture 300 presents an example system architecture according to the present techniques logically, and that there can be other implementations of the present techniques.

In system architecture 300, for a given configuration change for one or more microservices (e.g., configuration changes 112 of FIG. 1), configuration changes complexity analyzer component 316 can determine a complexity of the configuration changes. Canary plan generator component 318 can determine a plan for progressively deploying the new version of the microservice based on the result of configuration changes complexity analyzer component 316. Canary deployment orchestrator component 320 can implement a progressive deployment of the new version of the microservice based on the plan determined by canary plan generator component 318.

FIG. 4 illustrates an example graph 400 for increasing traffic directed to a canary version, and that can facilitate canary deployments based on configuration complexity in containerized environments, in accordance with an embodiment of this disclosure.

In some examples, information in graph 400 can be used by canary plan generator component 118 of FIG. 1 to determine a percentage of traffic to direct to a new version of a microservice (compared with a current, production version of the microservice) at various steps in a canary deployment.

Graph 400 comprises X-axis 402 (indicating a step number in a deployment), and Y-axis 404 (indicating a percentage of traffic directed to the new version of the microservice). Graphed on graph 400 are function 406 (displaying a linear progression in directing traffic to the new version of the microservice) and function 408 (displaying a Nth root progression in directing traffic to the new version of the microservice).

For example, the function can be a linear function, where there are N steps, and an additional D percent of traffic is sent to the canary deployment in each step. The last step can be 100% of traffic. In an example of six steps with 10% jumps, the respective percentages at each step can be 10%, 20%, 30%, 40%, 50%, and 100%.

In another example, the function can be a Nth root (or exponential) function. There can be N steps, and step K is (Nth root of 100) K. So, after N steps, the value can be 100%. This Nth root function can create a smooth, incremental exposure.

FIG. 5 illustrates an example configuration 500, and that can facilitate canary deployments based on configuration complexity in containerized environments, in accordance with an embodiment of this disclosure.

In some examples, information in configuration 500 can be used by canary deployments based on configuration complexity in containerized environments component 114 of FIG. 1 to determine a percentage of traffic to direct to a new version of a microservice (compared with a current, production version of the microservice) at various steps in a canary deployment.

Configuration 500 comprises configuration 502 and canary deployments based on configuration complexity in containerized environments component 514 (which can be similar to canary deployments based on configuration complexity in containerized environments component 114 of FIG. 1).

Configuration 502 is an example configuration allowing “orders” service instances to access Hypertext Transfer Protocol (HTTP) GET methods of a v1 version of a “pricing” service within a staging namespace. There can be an additional condition that the role of user who initiated the request is either a customer or an admin.

```
apiVersion: security.example.com/v1beta1
kind: AuthorizationPolicy
metadata:
  name: pricing
  namespace: staging
spec:
  selector:
  matchLabels:
    app: pricing
    version: v1
  action: ALLOW
  rules:
  - from:
  - source:
    principals: [“cluster.local/ns/default/sa/orders”]
  to:
  - operation:
    methods: [“GET”]
  when:
  - key: request.auth.claims[roles]
    values: [“customer”, “admin”]
```

The addition can be evaluated (for example) according to the criteria above either through the number of lines changed (11), depth (3), through the subject matter consideration (security), or through a combination of these.

A set of metrics that is evaluated can be considered, and in some examples, additional metrics can be incorporated into a complexity rank determination. In some examples, complexity rank can represent a sum of weighted complexities across all evaluated metrics.

In some examples, for each metric (i), a canary deployment operator can define:
Weight(i)—which can be a relative weight of the metric in total computation. A sum of all weights of all metrics evaluated can be 100.
MaxComplexity(i)—This can be a maximal complexity per metric (i) in total computation.
MinComplexity(i)—This can be a minimal complexity per metric (i) in total computation.
RawComplexity(i)—This can be an actual, unnormalized complexity per metric (i) in total computation.

Given this, determining a total complexity of a configuration change for n metrics can result in a number between 1 and 100, and can be determined as follows:

$$ComplexityRank = {\sum }_{i = 0}^{n} min ( Max Complexity ( i ) , max ( RawComplexity ( i ) , Min Complexity ( i ) ) ) / Max Complexity ( i ) * Weight ( i )$$

$$Under following assumption : {\sum }_{i = 0}^{n} Weight ( i ) = 100$$

That is, where the raw value is within the maximum and minimum bounds, the raw value is used. And otherwise use the maximum or minimum bound (whichever the raw value is outside). This value is divided by the maximum complexity to normalize it, then multiplied by the weight to weight it. This is done for each evaluated metric, and the evaluated metrics are summed to determine the ComplexityRank.

Values for Weight, MaxComplexity, and MinComplexity can be defined by a canary deployment operator for each metric.

Generating a canary deployment plan based on a configuration change's complexity can be implemented as follows. A canary plan generator can take a complexity rank that is determined by the configuration changes complexity analyzer in order to generate a canary deployment plan.

A canary deployment plan operator can predefine the following parameters. A parameter can be a number of requests per single complexity rank point. This parameter can specify how many requests should be forwarded to a canary version for each complexity rank point in the complexity rank of the configuration changes.

Another parameter can be a time per single complexity rank point. This parameter can specify how much time should be spent in the canary version step per single complexity rank point.

Another parameter can be a number of requests per step. This parameter can specify how many requests should be forwarded to a canary version per single canary deployment step. This can indicate a total number of steps in a canary deployment plan, where the total number of requests divided by the number of requests per step indicates the number of steps.

Consider the following example where the complexity rank is 100; the number of requests per single complexity rank point is 1,000; the time per single complexity rank point is 6 seconds; and the number of requests per step is 10,000.

In this example, a minimum total number of requests that should be forwarded to a canary version in order to fully switch to the canary version is 100*1,000=100,000.

A minimum total time that should be spent in the canary version of the microservice in order to switch fully to the canary version is 100*6=600 seconds.

A number of steps that the canary deployment plan has is 100,000/10,000=10. The time per each step is 600/10=60 seconds.

A canary deployment plan can be summarized as a triplet, [number of steps, number of requests to be forwarded to the canary version per step, time per step]. In this example the triplet is [10, 10000, 60].

That is, in order to be confident in the canary deployment, 10 steps are implemented. In each step, at least 10,000 requests are executed and a minimum of 60 seconds elapses before moving to the next step. The amount of traffic directed to the canary version at each step, using a Nth root function, is 1.58%, 2.51%, 3.98%, 6.31%, 10, 15.85%, 25.12%, 39.81%, 63.1%, 100%. That is, to move from step 3 to step 4, 10,000 requests must be forwarded to the canary version, while forwarding only 3.98% of all traffic to the canary version, and at least 60 seconds must elapse in this step even if enough requests are handled earlier.

Consider another example where the complexity rank is 50; the number of requests per single complexity rank point is 1,000; the time per single complexity rank point is 6 seconds; and the number of requests per step is 10,000.

In this example, a minimum total number of requests that should be forwarded to a canary version in order to fully switch to the canary version is 50*1,000=50,000.

A minimum total time that should be spent in the canary version of the microservice in order to switch fully to the canary version is 50*6=300 seconds.

A number of steps that the canary deployment plan has is 50,000/10,000=5. The time per each step is 300/5=60 seconds.

Using the above triplet notation to summarize a canary deployment plan, the triplet here is [5, 10,000, 60].

That is, in order to be confident in the canary deployment, 5 steps are implemented. In each step, at least 10,000 requests are executed and a minimum of 60 seconds elapses before moving to the next step. The amount of traffic directed to the canary version at each step, using a Nth root function, is 0.51%, 6.31%, 15.85%, 39.81%, 100%. That is, to move from step 3 to step 4, 10,000 requests must be forwarded to the canary version, while forwarding only 15.85% of all traffic to the canary version, and at least 60 seconds must elapse in this step even if enough requests are handled earlier.

Comparing these two examples, it can be seen that the complexity rank in the first example is higher than in the second example (100 v. 50)—that is, the first example is a riskier deployment. Hence, more requests must be forwarded in the first example than the second example (100,000 v. 50,000) before fully switching to the canary version. Also, the traffic percentage that is forwarded to the canary version is increased more slowly in the first example (10 steps) than in the second example (5 steps).

A formal canary deployment plan generation can be expressed as follows.

$$Total number of requests to switch full traffic to canary = [ Complexity rank ] * [ Number of requests per single complexity rank point ] .$$

$$Total time that should be spent in the canary version = [ Complexity rank ] * [ Time per single complexity rank point ] seconds .$$

$$Number of steps = [ Total number of requests to switch full traffic to canary version ] / [ Number of requests per step ] .$$

$$The time per each step = [ Total time that should be spent in the canary version ] / [ Number of steps ]$$

The final canary deployment plan can be summarized in a form of the following triplet: canary deployment plan=[Number of steps, Number of requests per step, Time per step].

Automatically orchestrating a canary deployment based on a generated canary deployment plan can be implemented as follows. A canary deployment orchestrator can receive a canary deployment plan from a canary plan generator, where the canary deployment plan expresses [Number of steps, Number of requests per step, Time per step].

The canary deployment orchestrator can then execute a canary deployment flow as follows. Per each step, the canary traffic percentage can be determined according to the percentage function (e.g., an Nth root function). Per each successful incoming request to the canary version, the counter of incoming requests per step can be increased. If the counter of incoming requests per step reached [Number of requests per step], and [Time per step] is reached, then the canary deployment orchestrator can move to the next step.

When the last step has finished successfully, all the traffic can be switched to canary version (and the canary version of the microservice can be labeled as production, while the “old” production microservice can be decommissioned).

If the canary deployment operator receives alerts based on user input and determines that there is a problem with the canary deployment, the deployment can be cancelled and 100% of the traffic can be forwarded back to the original production microservices. Through continuous integration/continuous deployment, it can be determined that a result produced by the canary version is likely correct. Problems identified during canary deployment can involve runtime problems, such as whether something is crashing, or there are stability or combability issues.

This operation of a canary deployment orchestrator can be expressed as:

```
foreach num in {1..., Number of steps}
[Request counter] <− 0
[Current time in step] <− 0
canary traffic percentage <− [percentage according to function]
Traffic split according to [canary traffic percentage]
foreach [Incoming request]
  if ([Incoming request].status == success)
    [Request counter] <− [Request counter] ++
  if ([Request counter] >= [Number of requests per step]
      && [Current time in step] >= [Time per step])
    break;
if (something crashed || request error>error_threshold)
  Deployment_status=failure
canary traffic percentage <− 100
if (deployment status == failure)
  canary traffic percentage <− 0
  decommission canary deployment
```

### Example Process Flows

FIG. 6 illustrates an example process flow 600 that can facilitate canary deployments based on configuration complexity in containerized environments, in accordance with an embodiment of this disclosure. In some examples, one or more embodiments of process flow 600 can be implemented by system architecture 100 of FIG. 1, or computing environment 1100 of FIG. 11.

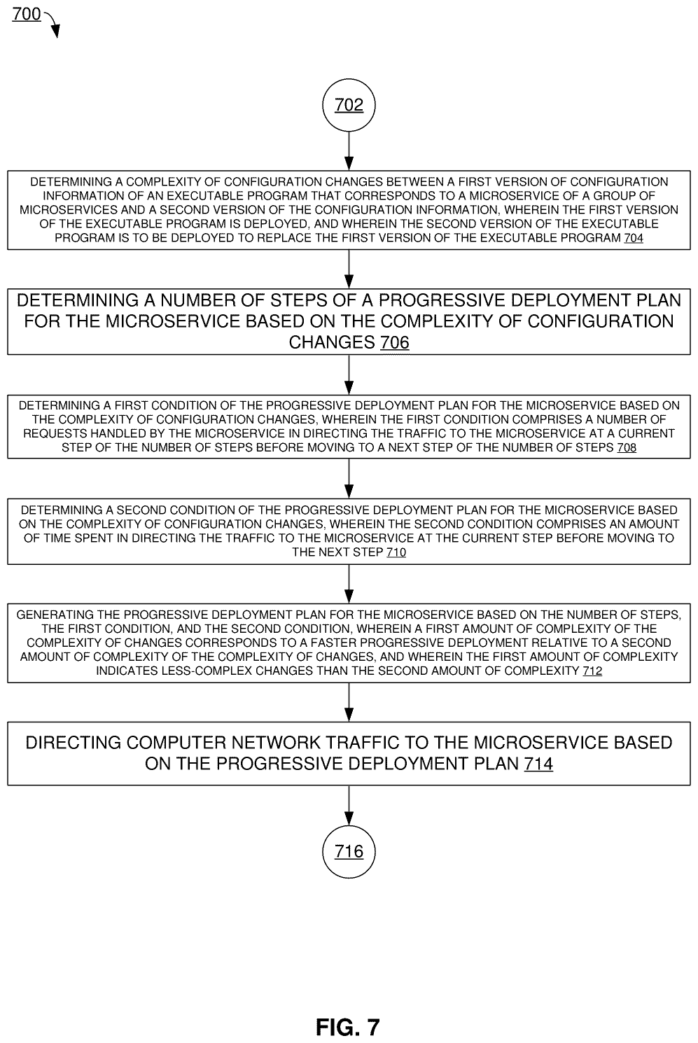

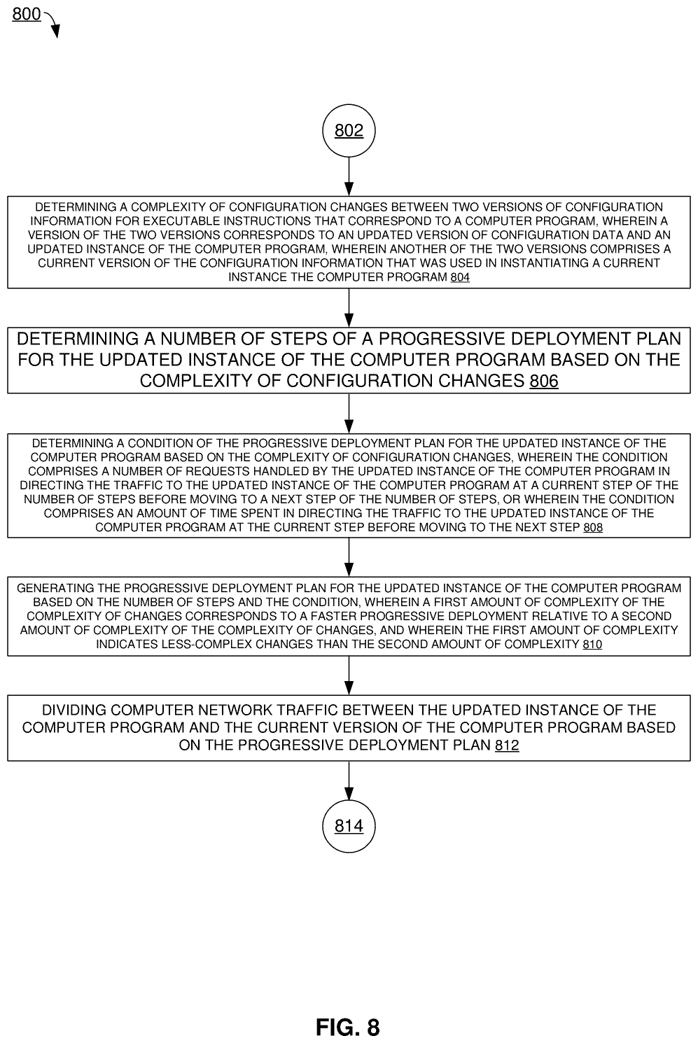

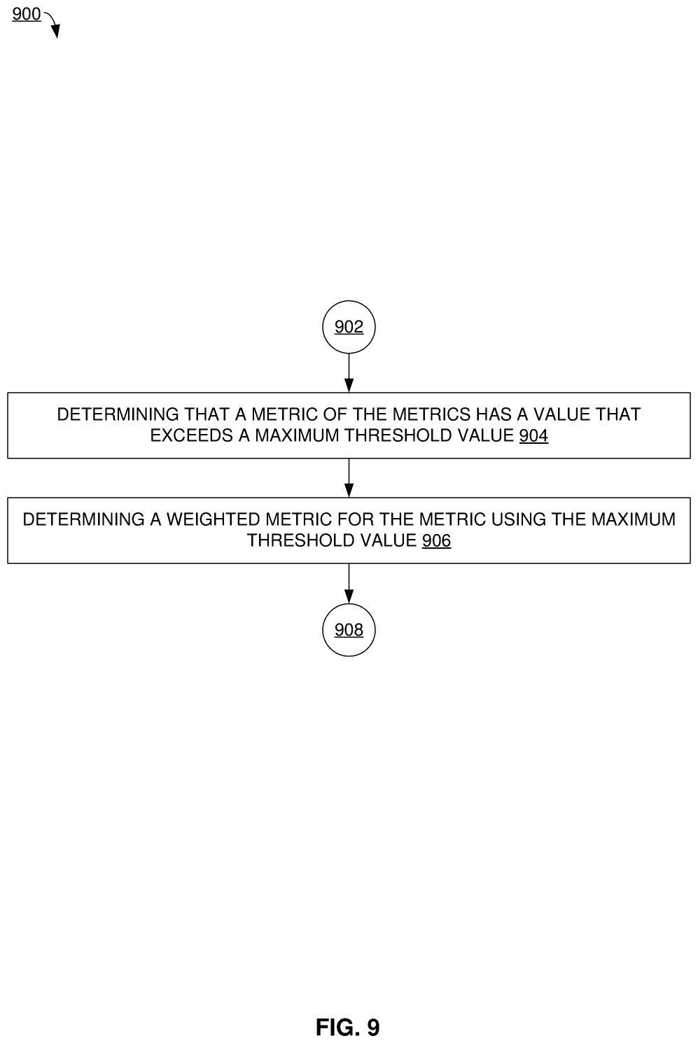

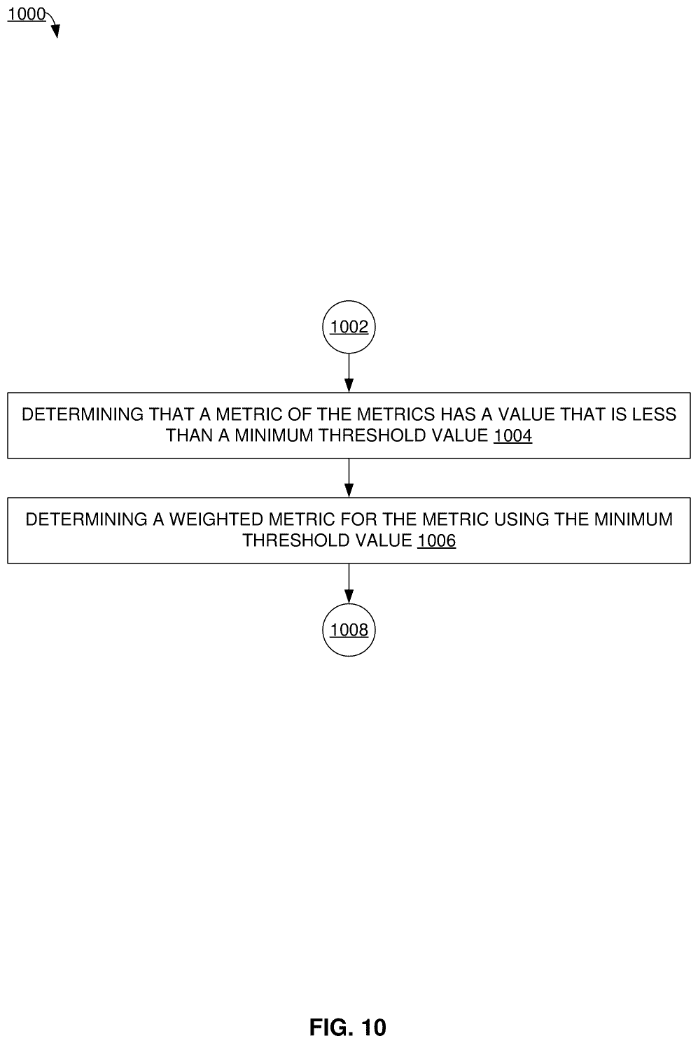

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts determining a complexity of configuration changes between a first version of configuration information of an executable program that corresponds to a microservice of a group of microservices and a second version of the configuration information, wherein the executable program is deployed according to the first version of the configuration information, and wherein the executable program is to be deployed according to the second version of the configuration information to replace the executable program deployed according to the first version of the configuration information. That is, there can be a microservices architecture, where the configuration information for a microservice has been updated, and the microservice will be deployed with the updated configuration information.

In some examples, the configuration information comprises metadata that indicates how to instantiate the executable program. That is, configuration information can be differentiated from the computer code itself of a microservice or program.

In some examples, the configuration information comprises information in a human-readable text format. That is, it can be that the configuration information is represented in an XML, JSON, or YAML format.

In some examples, the configuration information comprises a tree structure that comprises nodes, and wherein respective nodes of the nodes comprise a configuration setting, or a group of configuration settings. That is, different formats for a configuration information can comprise a tree structure, where each node represents either a specific configuration change or a grouping of the configuration changes.

In some examples, the complexity of configuration changes comprises a number of changed lines between the first version of configuration information and the second version of the configuration information. That is, more changed lines can indicate a higher complexity of changes.

In some examples, the complexity of configuration changes comprises an average path length from a root to leaves of the second version of the configuration information. That is, a longer average path length can indicate a higher complexity of changes.

In some examples, the complexity of configuration changes comprises an average number of children of nodes of the second version of the configuration information. That is, a greater average number of children of nodes can indicate a higher complexity of changes.

After operation 604, process flow 600 moves to operation 606.

Operation 606 depicts determining a number of steps of a progressive deployment plan for the microservice based on the complexity of the configuration changes. That is, the progressive deployment plan can comprise a list of steps and conditions to move to a next step in a canary deployment. The progressive deployment plan can be a canary deployment plan as described herein.

After operation 606, process flow 600 moves to operation 608.

Operation 608 depicts determining a first condition of the progressive deployment plan for the microservice based on the complexity of the configuration changes, wherein the first condition comprises a number of requests handled by the microservice in directing the traffic to the microservice at a current step of the number of steps before moving to a next step of the number of steps. That is, this can specify a counter of a minimum number of requests should be handled at a given step before progressing to a next step.

After operation 608, process flow 600 moves to operation 610.

Operation 610 depicts determining a second condition of the progressive deployment plan for the microservice based on the complexity of the configuration changes, wherein the second condition comprises an amount of time spent in directing the traffic to the microservice at the current step before moving to the next step. That is, this can specify a minimum amount of time to stay at a given step before progressing to a next step.

After operation 610, process flow 600 moves to operation 612.

Operation 612 depicts generating the progressive deployment plan for the microservice based on the number of steps, the first condition, and the second condition, wherein a first amount of complexity of the complexity of changes corresponds to a faster progressive deployment relative to a second amount of complexity of the complexity of changes, and wherein the first amount of complexity indicates less-complex changes than the second amount of complexity. That is, a progressive deployment plan can be generated that reflects the information of operations 606-610.

After operation 612, process flow 600 moves to operation 614.

Operation 614 depicts directing computer network traffic to the microservice based on the progressive deployment plan. In some examples, operation 614 can be implemented by canary deployment orchestrator component 120.

After operation 614, process flow 600 moves to 616, where process flow 600 ends.

FIG. 7 illustrates an example process flow 700 that can facilitate canary deployments based on configuration complexity in containerized environments, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts determining a complexity of configuration changes between a first version of configuration information of an executable program that corresponds to a microservice of a group of microservices and a second version of the configuration information, wherein the first version of the executable program is deployed, and wherein the second version of the executable program is to be deployed to replace the first version of the executable program. In some examples, operation 704 can be implemented in a similar manner as operation 604 of FIG. 6.

In some examples, the complexity of configuration changes comprises a percentage of non-leaf nodes of the second version of the configuration information. It can be that a higher percentage of non-leaf nodes indicates a lower complexity.

In some examples, the complexity of configuration changes comprises a percentage of leaf nodes of the second version of the configuration information. It can be that a higher percentage of non-leaf nodes indicates a higher complexity.

In some examples, the complexity of configuration changes comprises a number of interpolation points of the second version of the configuration information. These interpolation points can be, for example, placeholder values, where fewer placeholder values indicate a more complex configuration change.

In another example, interpolation points can indicate variables used. For example, a version for a configuration can be v3.2, where there is a desire to load v3.2 libraries as part of the configuration. Rather than explicitly stating v3.2 each time for each library, a template, reference, or variable lookup that specifies v3.2 can be used. It can be that, the more frequently a variable is used in this manner, the more complex the configuration change is determined to be.

In some examples, the complexity of configuration changes comprises a difference of a configuration of a scale-out limit between the first version of configuration information and the second version of the configuration information. That is, the configuration change can pertain to scale-out limits—e.g., a change from 1 to more than 1.

For example, it can be that 0 instances indicates that a particular feature is not used. Then, it can be that programming involved in one instance is generally simpler than programming involved for more than one instance. For example, programming involved for more than one instance can include increased considerations of coordination, locking, and the particular architecture model implemented, relative to the one-instance example.

In some examples, the complexity of configuration changes comprises a subject matter of a change between the first version of configuration information and the second version of the configuration information.

In some examples, the subject matter of the change comprises security. In some examples, the subject matter of the change comprises scaling. These subject matters can be considered to be more important than other subject matters, such as preferences for time zone, email address of user, or display.

After operation 704, process flow 700 moves to operation 706.

Operation 706 depicts determining a number of steps of a progressive deployment plan for the microservice based on the complexity of configuration changes. In some examples, operation 706 can be implemented in a similar manner as operation 606 of FIG. 6.

After operation 706, process flow 700 moves to operation 708.

Operation 708 depicts determining a first condition of the progressive deployment plan for the microservice based on the complexity of configuration changes, wherein the first condition comprises a number of requests handled by the microservice in directing the traffic to the microservice at a current step of the number of steps before moving to a next step of the number of steps. In some examples, operation 708 can be implemented in a similar manner as operation 606 of FIG. 6.

After operation 708, process flow 700 moves to operation 710.

Operation 710 depicts determining a second condition of the progressive deployment plan for the microservice based on the complexity of configuration changes, wherein the second condition comprises an amount of time spent in directing the traffic to the microservice at the current step before moving to the next step. In some examples, operation 710 can be implemented in a similar manner as operation 610 of FIG. 6.

After operation 710, process flow 700 moves to operation 712.

Operation 712 depicts generating the progressive deployment plan for the microservice based on the number of steps, the first condition, and the second condition, wherein a first amount of complexity of the complexity of changes corresponds to a faster progressive deployment relative to a second amount of complexity of the complexity of changes, and wherein the first amount of complexity indicates less-complex changes than the second amount of complexity. In some examples, operation 712 can be implemented in a similar manner as operation 612 of FIG. 6.

After operation 712, process flow 700 moves to operation 714.

Operation 714 depicts directing computer network traffic to the microservice based on the progressive deployment plan. In some examples, operation 714 can be implemented in a similar manner as operation 614 of FIG. 6.

After operation 714, process flow 700 moves to 716, where process flow 700 ends.

FIG. 8 illustrates an example process flow 800 that can facilitate canary deployments based on configuration complexity in containerized environments, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts determining a complexity of configuration changes between two versions of configuration information for executable instructions that correspond to a computer program, wherein a version of the two versions corresponds to an updated version of configuration data and an updated instance of the computer program, wherein another of the two versions comprises a current version of the configuration information that was used in instantiating a current instance the computer program. In some examples, operation 804 can be implemented in a similar manner as operation 604 of FIG. 6.

After operation 804, process flow 800 moves to operation 806.

Operation 806 depicts determining a number of steps of a progressive deployment plan for the updated instance of the computer program based on the complexity of configuration changes. In some examples, operation 806 can be implemented in a similar manner as operation 606 of FIG. 6.

After operation 806, process flow 800 moves to operation 808.

Operation 808 depicts determining a condition of the progressive deployment plan for the updated instance of the computer program based on the complexity of configuration changes, wherein the condition comprises a number of requests handled by the updated instance of the computer program in directing the traffic to the updated instance of the computer program at a current step of the number of steps before moving to a next step of the number of steps, or wherein the condition comprises an amount of time spent in directing the traffic to the updated instance of the computer program at the current step before moving to the next step. In some examples, operation 808 can be implemented in a similar manner as operations 608-610 of FIG. 6.

In some examples, the complexity of configuration changes comprises a group of changes, wherein respective changes are associated with respective metrics, wherein the respective metrics are associated with respective weights, and wherein determining the complexity of configuration changes is based on the respective weights. That is, in some examples, each metric can be associated with a weight that can reflect that metric's significance for a determination of a complexity of the configuration change.

In some examples, the complexity of configuration changes comprises a normalized numerical value. That is, the complexity data can be a complexity risk that is normalized to range between 1 and 100.

After operation 808, process flow 800 moves to operation 810.

Operation 810 depicts generating the progressive deployment plan for the updated instance of the computer program based on the number of steps and the condition, wherein a first amount of complexity of the complexity of changes corresponds to a faster progressive deployment relative to a second amount of complexity of the complexity of changes, and wherein the first amount of complexity indicates less-complex changes than the second amount of complexity. In some examples, operation 810 can be implemented in a similar manner as operation 612 of FIG. 6.

After operation 810, process flow 800 moves to operation 812.

Operation 812 depicts dividing computer network traffic between the updated instance of the computer program and the current version of the computer program based on the progressive deployment plan. In some examples, operation 812 can be implemented in a similar manner as operation 614 of FIG. 6.

After operation 812, process flow 800 moves to 814, where process flow 800 ends.

FIG. 9 illustrates an example process flow 900 that can facilitate canary deployments based on configuration complexity in containerized environments, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts determining that a metric of the metrics has a value that exceeds a maximum threshold value. That is, a maximum threshold value for a metric can be specified—e.g., 50, where all measured values over 50 exceed the threshold.

After operation 904, process flow 900 moves to operation 906.

Operation 906 depicts determining a weighted metric for the metric using the maximum threshold value. That is, where a measured value exceeds the maximum value, the maximum value can be used in place of the measured value. This can be similar to MaxComplexity(i).

After operation 906, process flow 900 moves to 908, where process flow 900 ends.

FIG. 10 illustrates an example process flow 1000 that can facilitate canary deployments based on configuration complexity in containerized environments, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts determining that a metric of the metrics has a value that is less than a minimum threshold value. That is, a maximum threshold value for a metric can be specified—e.g., 3, where all measured values under 3 are less than the threshold.

After operation 1004, process flow 1000 moves to operation 1006.

Operation 1006 depicts determining a weighted metric for the metric using the minimum threshold value. That is, where a measured value is less than the minimum value, the minimum value can be used in place of the measured value. This can be similar to MinComplexity(i).

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of server 102 and/or client 106 of FIG. 1.

In some examples, computing environment 1100 can implement one or more embodiments of the process flows of FIGS. 6-10 to canary deployments based on configuration complexity in containerized environments.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per sc.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
a memory that stores executable instructions that, when executed by the at least one processor, facilitate performance of operations, comprising:
determining a complexity of configuration changes between a first version of configuration information of an executable program that corresponds to a microservice of a group of microservices and a second version of the configuration information, wherein the executable program is deployed according to the first version of the configuration information, and wherein the executable program is to be deployed according to the second version of the configuration information to replace the executable program deployed according to the first version of the configuration information;
determining a number of steps of a progressive deployment plan for the microservice based on the complexity of the configuration changes;
determining a first condition of the progressive deployment plan for the microservice based on the complexity of the configuration changes, wherein the first condition comprises a number of requests handled by the microservice in directing the traffic to the microservice at a current step of the number of steps before moving to a next step of the number of steps;
determining a second condition of the progressive deployment plan for the microservice based on the complexity of the configuration changes, wherein the second condition comprises an amount of time spent in directing the traffic to the microservice at the current step before moving to the next step;
generating the progressive deployment plan for the microservice based on the number of steps, the first condition, and the second condition, wherein a first amount of complexity of the complexity of changes corresponds to a faster progressive deployment relative to a second amount of complexity of the complexity of changes, and wherein the first amount of complexity indicates less-complex changes than the second amount of complexity; and
directing computer network traffic to the microservice based on the progressive deployment plan.

2. The system of claim 1, wherein the configuration information comprises metadata that indicates how to instantiate the executable program.

3. The system of claim 1, wherein the configuration information comprises information in a human-readable text format.

4. The system of claim 1, wherein the configuration information comprises a tree structure that comprises nodes, and wherein respective nodes of the nodes comprise a configuration setting, or a group of configuration settings.

5. The system of claim 1, wherein the complexity of configuration changes comprises a number of changed lines between the first version of configuration information and the second version of the configuration information.

6. The system of claim 1, wherein the complexity of configuration changes comprises an average path length from a root to leaves of the second version of the configuration information.

7. The system of claim 1, wherein the complexity of configuration changes comprises an average number of children of nodes of the second version of the configuration information.

8. A method, comprising:
determining, by a system comprising at least one processor, a complexity of configuration changes between a first version of configuration information of an executable program that corresponds to a microservice of a group of microservices and a second version of the configuration information, wherein the first version of the executable program is deployed, and wherein the second version of the executable program is to be deployed to replace the first version of the executable program;
determining, by the system, a number of steps of a progressive deployment plan for the microservice based on the complexity of configuration changes;
determining, by the system, a first condition of the progressive deployment plan for the microservice based on the complexity of configuration changes, wherein the first condition comprises a number of requests handled by the microservice in directing the traffic to the microservice at a current step of the number of steps before moving to a next step of the number of steps;
determining, by the system, a second condition of the progressive deployment plan for the microservice based on the complexity of configuration changes, wherein the second condition comprises an amount of time spent in directing the traffic to the microservice at the current step before moving to the next step;
generating, by the system, the progressive deployment plan for the microservice based on the number of steps, the first condition, and the second condition, wherein a first amount of complexity of the complexity of changes corresponds to a faster progressive deployment relative to a second amount of complexity of the complexity of changes, and wherein the first amount of complexity indicates less-complex changes than the second amount of complexity; and
directing, by the system, computer network traffic to the microservice based on the progressive deployment plan.

9. The method of claim 8, wherein the complexity of configuration changes comprises a percentage of non-leaf nodes of the second version of the configuration information.

10. The method of claim 8, wherein the complexity of configuration changes comprises a percentage of leaf nodes of the second version of the configuration information.

11. The method of claim 8, wherein the complexity of configuration changes comprises a number of interpolation points of the second version of the configuration information.

12. The method of claim 8, wherein the complexity of configuration changes comprises a difference of a configuration of a scale-out limit between the first version of configuration information and the second version of the configuration information.

13. The method of claim 8, wherein the complexity of configuration changes comprises a subject matter of a change between the first version of configuration information and the second version of the configuration information.

14. The method of claim 11, wherein the subject matter of the change comprises security.

15. The method of claim 11, wherein the subject matter of the change comprises scaling.

16. A non-transitory computer-readable medium comprising instructions that, in response to execution, cause a system comprising at least one processor and facilitating execution of a computing service to perform operations, comprising:
determining a complexity of configuration changes between two versions of configuration information for executable instructions that correspond to a computer program, wherein a version of the two versions corresponds to an updated version of configuration data and an updated instance of the computer program, wherein another of the two versions comprises a current version of the configuration information that was used in instantiating a current instance the computer program;
determining a number of steps of a progressive deployment plan for the updated instance of the computer program based on the complexity of configuration changes;
determining a condition of the progressive deployment plan for the updated instance of the computer program based on the complexity of configuration changes,
wherein the condition comprises a number of requests handled by the updated instance of the computer program in directing the traffic to the updated instance of the computer program at a current step of the number of steps before moving to a next step of the number of steps, or
wherein the condition comprises an amount of time spent in directing the traffic to the updated instance of the computer program at the current step before moving to the next step;
generating the progressive deployment plan for the updated instance of the computer program based on the number of steps and the condition, wherein a first amount of complexity of the complexity of changes corresponds to a faster progressive deployment relative to a second amount of complexity of the complexity of changes, and wherein the first amount of complexity indicates less-complex changes than the second amount of complexity; and
dividing computer network traffic between the updated instance of the computer program and the current version of the computer program based on the progressive deployment plan.

17. The non-transitory computer-readable medium of claim 16, wherein the complexity of configuration changes comprises a group of changes, wherein respective changes are associated with respective metrics, wherein the respective metrics are associated with respective weights, and wherein determining the complexity of configuration changes is based on the respective weights.

18. The non-transitory computer-readable medium of claim 17, wherein the operations further comprise:
determining that a metric of the metrics has a value that exceeds a maximum threshold value; and
determining a weighted metric for the metric using the maximum threshold value.

19. The non-transitory computer-readable medium of claim 17, wherein the operations further comprise:
determining that a metric of the metrics has a value that is less than a minimum threshold value; and
determining a weighted metric for the metric using the minimum threshold value.

20. The non-transitory computer-readable medium of claim 16, wherein the complexity of configuration changes comprises a normalized numerical value.
